(19) United States
(12) Patent Application Publication
(10) Pub. No.: US 2002/0071424 A1
(43) Pub. Date: Jun. 13, 2002

(54) Packet voice telephony apparatus and method

(76) Inventors: King W. Chiu, Calgary (CA); Paul Hanreider, Calgary (CA); Todd R. Hunter, Calgary (CA)

Correspondence Address: John Crane, Nortel Networks, P.O. Box 832130, Richardson, TX, 75083-2130, US

(21) Appl. No.: 09/735,667

(22) Filed: Dec. 12, 2000

(51) Int. Cl. H04L 12/66

(52) U.S. Cl. 370/352; 370/463

(57) ABSTRACT

According to the present disclosure, connectionless base IP protocol is leveraged to transfer streaming voice to a destination telephony device. As such, the disclosed IP telephony peripheral adjunct to a computer includes an interface to the computer, a controller and memory specifying the destination IP address, a packetizer coupled to the controller and memory for packetizing outbound digitized voice into at least one outbound IP packet, and a network interface for transmitting the outbound IP network onto a network which may involve a LAN, WAN or the Internet. The disclosed IP phone peripheral also includes an extractor coupled to the memory and controller for extracting inbound digitized voice within an incoming IP packet whose source address correlates to the destination IP address or addresses stored in the memory.

### FIELD OF INVENTION

This invention is generally concerned with packet network telephony, and is particularly concerned with a packet voice telephone architecture in a device adjunct to a computer.

### BACKGROUND

Within the past few years, a lot of interest, hype, and money has been spent on making practical use of the Internet. One of the most promising new technologies, and the one which may offer consumers the first real alternative to conventional switched telephone service, is Internet telephony. Simply put, Internet telephony is directed to using the Internet as the transport for telephone calls. Unlike the traditional telephone call, in Internet telephony, the use of the public switched telephone network is minimized, and instead the Internet backbone is used as the primary long-haul communications carrier. By leveraging fixed cost Internet access and global points of presence (the parties to the call could be as close as next door or as far away as the next hemisphere), Internet telephony could significantly reduce or even eliminate the time and distance costs heretofore expected in a long distance call utilizing the public switched telephone network (“PSTN”).

In a conventional Internet telephony session, an originating computer having a TCP/IP stack and a communications pathway to the Internet establishes a TCP virtual circuit or UDP connection with a destination computer also having its own TCP/IP stack and communications pathway to the Internet. Once the TCP virtual circuit or UDP connection is established, analog voice perceived at the source computer is converted into streaming data and sent over the Internet in a series of TCP/IP or UDP/IP packets. The destination computer receives the so-packetized streaming data and converts it back to analog form as it is received. The destination may likewise transfer locally perceived streaming voice back to the source to enable two-way voice communications between the source and destination users, much like the traditional telephone call.

Some of the known Internet telephony implementations are software-based, running on a computer, and require sophisticated multimedia computing resources being utilized by both the originating and destination points in order to establish and maintain the call. This is because these computing resources are designed to utilize the Internet in its traditional role as an asynchronous data communications network, and as such, need a reliable way to transfer information. The TCP protocol provides increased reliability, since a single data route is selected and all TCP transferred data is checked at the destination to ensure all data is received in satisfactory condition (otherwise, the destination requests the source to resend the missing or corrupted packets). This protocol is great for transferring a data file or an application that doesn't work if even a small piece of data is missing. However, TCP has limitations when real-time streaming data such as voice is being transmitted, since it requires that the destination confirm delivery of each packet and request the source to resend it if it doesn't show up; and this adds to the load the on the processor, which may be running other applications also.

As a result, some known software-based telephony applications can be configured to attempt Internet telephony communications using UPD, real time protocol (“RTP”), real time control protocol (“RTCP”), or the real time streaming protocol (“RTSP”), all of which sacrifice TCP's transmission reliability to some degree in exchange for enhanced throughput and/or adding special timing information relevant to streaming data transmission. While these protocols offer improved real-time streaming data transmission performance over TCP, they nevertheless saddle the Internet telephony application and a computer apparatus with complicated negotiation and delivery requirements, which still require advanced computing resources to handle.

Moreover, when computers run many tasks and applications simultaneously, problems may occur with resource allocation. The result of this may add delay, echo, or at worst, the computing resource may ‘hang’ due to processing or resource overload, thus affecting the call.

Therefore, it would be desirable if a simple computer-interfaced telephony device were developed which could simultaneously transmit and receive packetized streaming voice data without the encumbrances imposed by existing reliable data communication or real-time protocols on computer systems.

### SUMMARY OF THE INVENTION

Accordingly, the present invention is directed to a packet voice telephone peripheral adjunct to a computer and telephony system incorporating the same. Consistent with a first embodiment of the present invention, the connectionless Layer 3 IP protocol is used to transfer streaming voice. As such, the IP telephony peripheral of the first embodiment includes a controller and memory specifying the destination address or addresses, a packetizer coupled to the controller and memory for packetizing outbound digitized voice into at least one outbound IP packet, and a network interface for transmitting the outbound IP packet onto a network which may include the Internet. As used here, a “destination address” may be a telephone number, a DN key, an IP address or any other identifier associated with the telephony apparatus herein described. Preferably, this IP telephony peripheral also includes an extractor coupled to the memory and controller for extracting inbound digitized voice within an incoming IP packet whose source address correlates to the destination IP address or addresses stored in the memory.

The IP telephone according to the first embodiment of the present invention preferably communicates with a call server having a predetermined IP address in order to resolve user input into a viable destination IP address for establishing a call, as well as implement advanced call features such as forwarding and conferencing. To establish the call, the IP telephone packetizer may transmit a predefined call request IP packet to this phone server using the predetermined IP address as the destination address. The phone server will utilize a call model for resolving or verifying requested destination information specified by the user and contained in the data portion of the call request IP packet, and either issues a connection reply containing the resolved or verified destination IP address, or a connection error if the phone server is unable to decipher or confirm the desired destination information. In turn, the IP telephone controller will identify the server feedback and, if a connection reply is perceived, the destination IP address specified in the reply is placed in IP telephone memory. Thereafter, the packetizer will route digitized voice packets to this stored address.

According to a second embodiment of the invention, OSI level 4 and higher layer protocols (such as TCP/IP and ITU H.323) can be preserved through encapsulation, redirection, and resolution of such layer control. To this end, the IP telephone of the second embodiment will include a controller capable of directly or indirectly determining whether an incoming packet includes control information germane to the layer 4+ protocol being supported. If this controller determines that the received packet includes such control information which it cannot process internally, it encapsulates the received control information into an outbound layer 3 packet and directs that it be sent to the phone server using base IP protocols.

The phone server receives inbound layer 4+ control information, and, using appropriate higher layer service routines, extracts the control information and formulates a response. Then, the phone server encapsulates and broadcasts the response to the IP telephone using Layer 3 IP protocols and the controller of the IP telephone routes it to the destination in native higher layer format. In such way, the phone server of the second embodiment acts as a control, receipt and response intermediary that is transparent to the destination telephony device. Moreover, layer 4+ protocols can be supported while adding minimal processing functionality to the IP telephone controller, thereby keeping IP telephone costs low.

Preferably, the IP telephone of the first and second embodiments will include connection facilities to connect a handset, a headset or speaker/microphone combination much like a conventional telephone, and appropriate analog/digital converter circuitry coupled to the aforementioned extractor and packetizer for converting voice acquired by the handset microphone into outbound digitized voice as well as for converting inbound digitized voice into analog for playback in the speaker.

In addition, preferably, the IP telephone according to the first and second embodiments of the invention includes a thin-client representing a phone-like keypad for eliciting desired destination identification information from the user. The destination information may consist of the destination's address or addresses, or other information from which the destination address can be locally or remotely resolved. In addition, a display may be provided so that the user can e.g. self-verify her keypad entry or identify the calling party.

A further advantage of the present invention is that it saves power by reducing the load on a computer processor and therefore it materially contributes to the more efficient utilization and conservation of energy resources.

Other aspects and features of the present invention will become apparent to those ordinarily skilled in the art upon review of the following description of the specific preferred embodiments of the invention in conjunction with the accompanying figures.

### BRIEF DESCRIPTION OF THE DRAWINGS

The features of the invention, as well as the invention itself may be best understood with reference to the following drawings, in which like numbers indicate like parts, to which:

FIG. 1 is a system diagram implementing an IP telephony peripheral according to a first embodiment of the invention;

FIG. 2 is a block diagram of a multimedia computer system, in accordance with the first and second embodiments of the invention;

FIG. 3 is a simplified computer-screen based interface of the IP telephony peripheral of FIG. 1;

FIG. 4 is a schematic block diagram of the IP telephone of FIGS. 1 and 6;

FIG. 5 is a state transition diagram for the controller of FIG. 4 according to the first embodiment of the invention;

FIG. 6 is a system diagram implementing an IP telephony peripheral according to a second embodiment of the invention; and

FIG. 7 is a state transition diagram for the controller of FIG. 4 according to the second embodiment of the invention.

### DETAILED DESCRIPTION OF THE PREFERRED EMBODIMENTS

In the following detailed description, references are made to the accompanying drawings which form a part hereof and in which is shown by way of illustration specific embodiments in which the invention may be practiced. These embodiments are described in sufficient detail to enable those ordinarily skilled in the art to practice the invention, and it is to be understood that other embodiments may be utilized in that structural, logical, and electrical changes may be made without departing from the spirit and scope of the invention. The following detailed description is, therefore, not to be taken in the limiting sense, and the scope of the present invention is to be defined solely by the appended claims.

One known implementation to address some of the aforementioned problems is the Nortel Networks i2004 Internet Telephone, of Nortel Networks, Brampton, Ontario, Canada, which is a hardware based telephony apparatus compatible with MGCP and H.323 devices. This is a stand-alone IP telephone client device which connects to an IP network directly and provides the familiarity and ease-of-use of a traditional telephone. Also known, is commonly owned application titled “Packet Voice Telephony System and Method”, Ser. No. 09/224,548, filed Dec. 31, 1998, which is herein incorporated by reference.

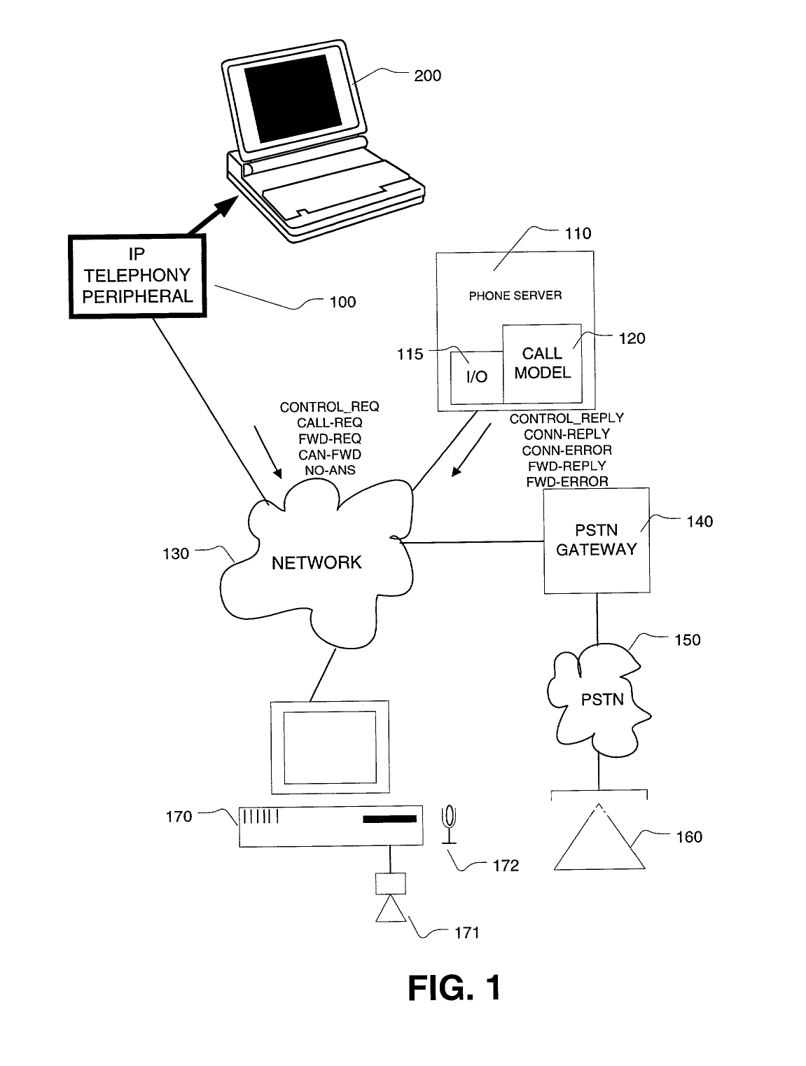

A system diagram including the IP telephone of the first embodiment is shown with reference to FIG. 1. As shown in the figure, Internet telephone peripheral 100 is coupled to computer 200. Internet telephone peripheral 100 is also coupled to network 130, which can comprise a LAN/WAN or the Internet. As will be discussed in greater detail hereinbelow, the IP telephony peripheral 100 will include sufficient network resources to enable the broadcast receipt of Internet protocol (“IP”) packets of digitized voice to and from other telephony devices in communication with the network 130.

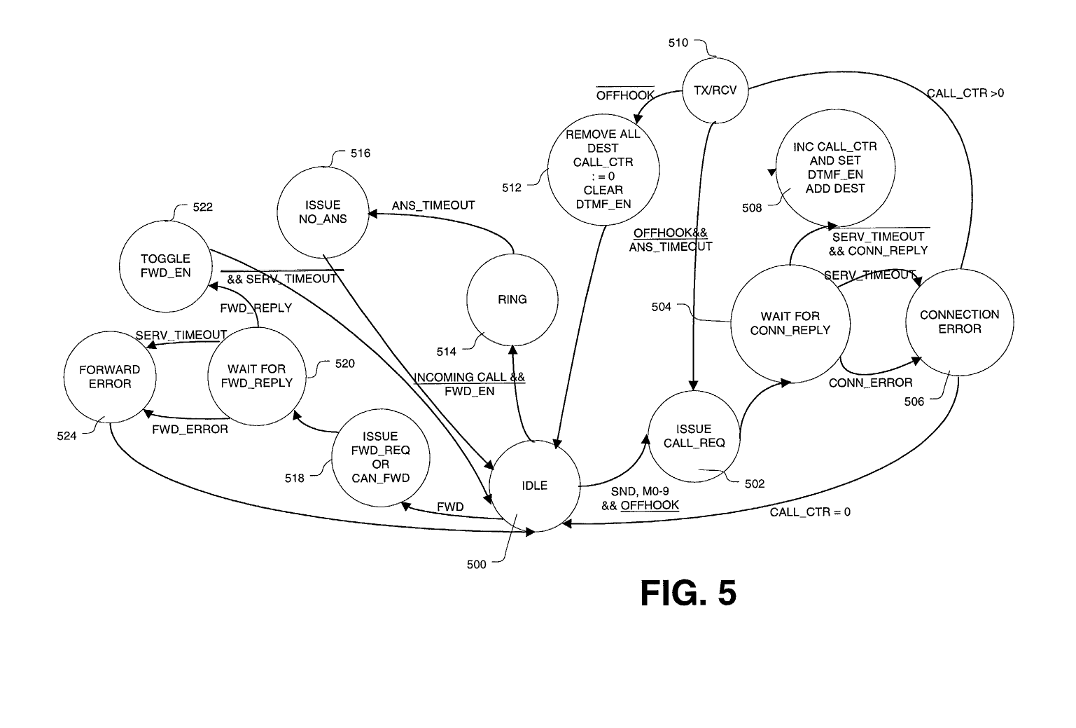

Also coupled to the network 130 is a phone server 110. This phone server is used to resolve call requests emanating from the Internet telephone peripheral 100 as well as issued connection replies or connection errors in response thereto. Such call requests will be received by, and resulting connection replies or errors transmitted by the network 130 aware I/O module 115 of the phone server 110. A call model 120 within the phone server 110 will be used to resolve destination information contained in the call request and indicate whether the connection reply or connection errors should be transmitted by the aforementioned I/O module 115 to the requesting IP telephony peripheral 100. The call model 120 is also assigned to handle forward requests and forward cancellation requests issued by the IP telephony peripheral 100, and so will direct the I/O module 115 to issue the appropriate forward reply or forward error to the requesting IP telephony peripheral 100. A more detailed description of the requests (e.g. CONTROL_REQ, CALL_REQ, FWD_REQ, CAN_FWD) replies (CONTROL_REPLY, CONN_REPLY, FWD_REPLY) and errors (CONN_ERROR, FWD_ERROR, NO_ANS) issued by the IP telephony peripheral 100 or phone server 110 shown in FIG. 1, as well as their interpretation and handling, will be discussed in more detail below with reference to the block diagram of FIG. 5.

Still referring to FIG. 1, also coupled to network 130 is PSTN gateway 140 to allow communications between IP telephony peripheral 100 and/or other devices connected to the network such as computer 170 to communicate to a remote telephone 160 via the public switched telephone network (“PSTN”) 150. PSTN gateway 140 and computer 170 are conventional telephony devices well known in the art and accordingly detailed description thereof is omitted herein other than to amplify the principles of the present invention.

It should be noted here that through the call establishment and IP packet transmission procedures discussed below, Internet telephone peripheral 100 may be able to invoke and maintain an Internet telephony session with multimedia computer 170 including microphone 172 and speaker 171 connected to network 130 or even conventional telephone 160 connected to network 130 via the aforementioned PSTN gateway 140. Also, although not shown in figure, the IP telephony peripheral 100 may also place a voice over IP telephone call and maintain a call with a like IP telephone, as will readily be understood by those ordinarily skilled in the art upon review of this disclosure.

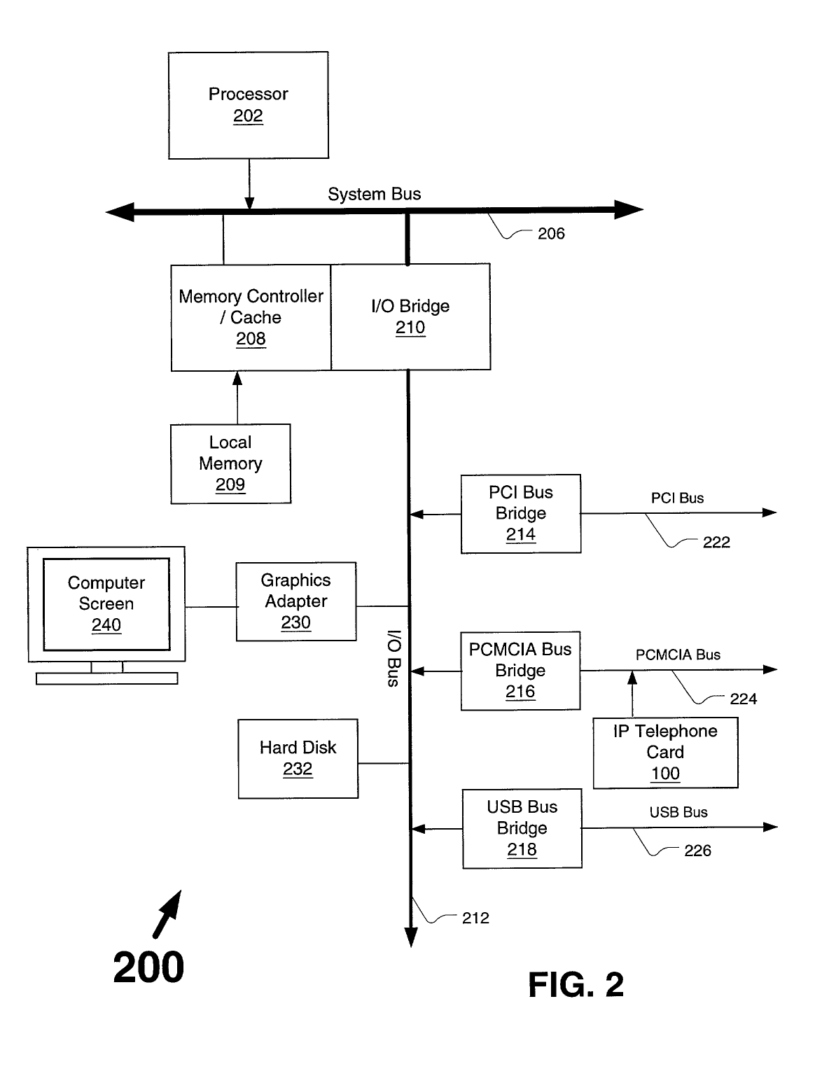

Referring now to FIG. 2, a block diagram of a multimedia computer, which may be implemented in accordance with both the first and second embodiments of the present invention is depicted. Multimedia computer 200, in this example, is a single processor system including a processor 202 connected to system bus 206. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 222. A number of peripheral components may be connected to PCI bus 222. Typical PCI bus implementations will support four PCI expansion slots or add-in connectors. Also connected to I/O bus 212 is Personal Computer Memory Card International Association (PCMCIA) bus bridge 216, which supports PCMCIA bus connectors connected via PCMCIA Bus 224. Presently, there are four physical standards for PCMCIA cards; type I, II, III and IV. This invention may be implemented using any of these peripheral standards. In addition, connected to I/O bus 212 is Universal Serial Bus (USB) bus bridge 218, which supports peripherals via a USB connector and communications protocol connected via USB Bus 226. As may be seen from FIG. 2. IP telephony peripheral 100 is coupled via PCMCIA Bus 224, though preferably, the invention of the first and second embodiments is implemented on a circuit board that connects via one of these aforesaid bus connectors. Independent of which connector is used; a common feature of the various implementations that the present invention may take is that the circuitry on the peripheral device adjunct to multimedia computer 200 communicates with the multimedia computer components over I/O bus 212.

A memory-mapped graphics adapter 230 and hard disk 232 may also be connected to I/O bus 212 as depicted, either directly or indirectly. A computer-screen 240 is connected to graphics adapter 230 for graphical display. Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. For example, although a number of different buses are illustrated as providing interconnects between the various components, other mechanisms other than the buses illustrated may be used to provide interconnects between the various components illustrated.

The multimedia computer depicted in FIG. 2 may be, for example, an IBM personal computer system, a product of International Business Machines Corporation in Armonk, New York, running the Microsoft Windows NT operating system, a product of Microsoft Corporation, Redmond, Wash.

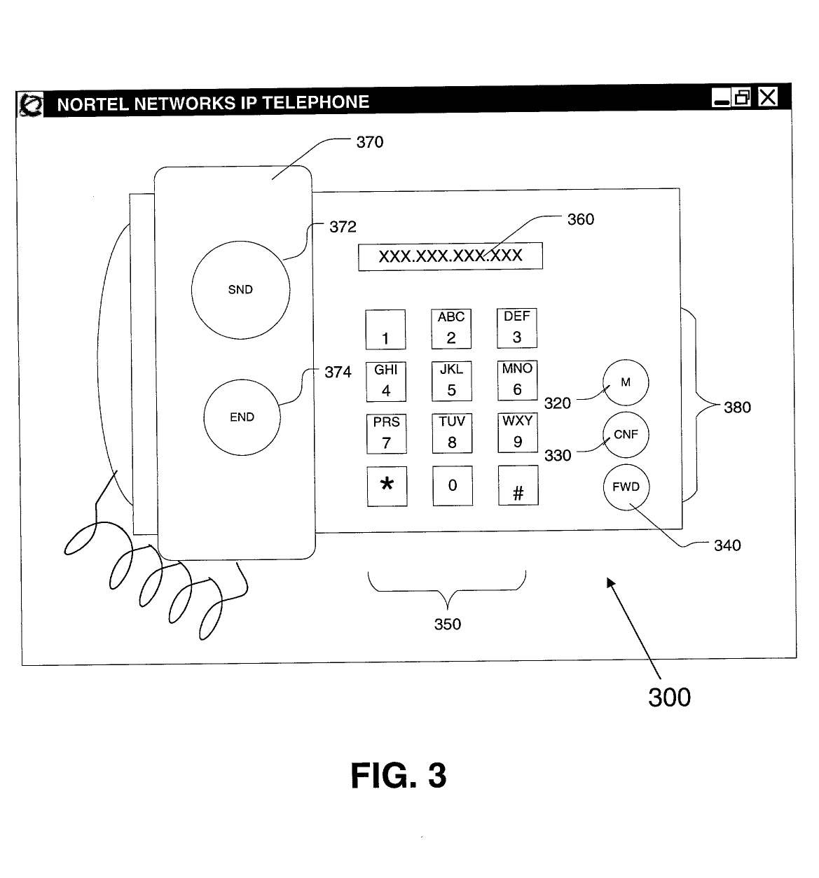

Turning now to FIG. 3 the simplified computer-screen based graphical user interface (GUI) of the IP telephony peripheral 100 of FIG. 1 indicates the major external functional components of the Internet telephone computer-screen based GUI according to the first and second embodiments of the invention as may be displayed on computer screen 240 of FIG. 2. As shown therein, IP telephony peripheral GUI 300 takes on the general appearance of a conventional PSTN telephone on a computer screen, and as such a representation of handset 370 is included to simulate the appearance of a conventional PSTN telephone. IP telephony peripheral GUI 300 may be implemented on a windows-based graphical user interface, an example of which is Microsoft Windows NT of the Microsoft Corporation, Redmond, Wash. As shown on handset 370, a send (SND) key 372 to connect a call and an end key 374 to end the call is included to initiate the off-hook and on-hook states. Soft keypad 380 including phone keys 350 are disposed on the IP telephony peripheral screen GUI 300 of the IP telephony peripheral 100 arranged as in the case of a conventional telephone. The soft keypad is used by the Internet telephone peripheral 100 to capture user input conveying destination information as well as selectively activate or deactivate advanced calling features such as conference (CNF) and forward (FWD). As will be discussed hereinbelow with reference to FIG. 5, according to the present embodiment, the user will specify destination information by entering a sequence of digits using phone keys 350 accompanied by selection of the send key (SND) 372 or the memory key (M) 320 followed by one or more of the digit phone keys 0-9. These keys are activated by key input on the computer, by mouse click on the appropriate key, or if the computer has a touch-sensitive display, by direct screen input. Destination information may also be entered using voice activation techniques, as commonly known in the art. It should be realized here that requiring the user to terminate entry with a predetermined keystroke (the send key) or sequence of strokes (the memory key followed by one of the digit phone keys 0-9) greatly simplifies acquisition of the user entry as well as the error-checking and interpretation thereof, at least with respect to the IP telephony peripheral 100.

A display 360 is also provided on IP telephony peripheral screen GUI 300 for providing user feedback regarding the digits keyed in via keypad 380 of the IP telephony peripheral screen GUI 300 and/or the status of the phone itself as well as that of the remote phone server 110. Also, in the case of an incoming call, information involving the calling or called party may be obtained and displayed as is with the case of conventional calling line identification technology, since the originating VOIP device(s) IP address is contained in each packet received by the IP telephone. In addition, the display 360 may be used to provide visual cues to the user regarding the request and reply transactions used in establishing a call according to the present embodiment.

A detailed discussion of the conference (CNF) 330 and the forward (FWD) 340 keys will be discussed hereinbelow with reference to FIG. 5.

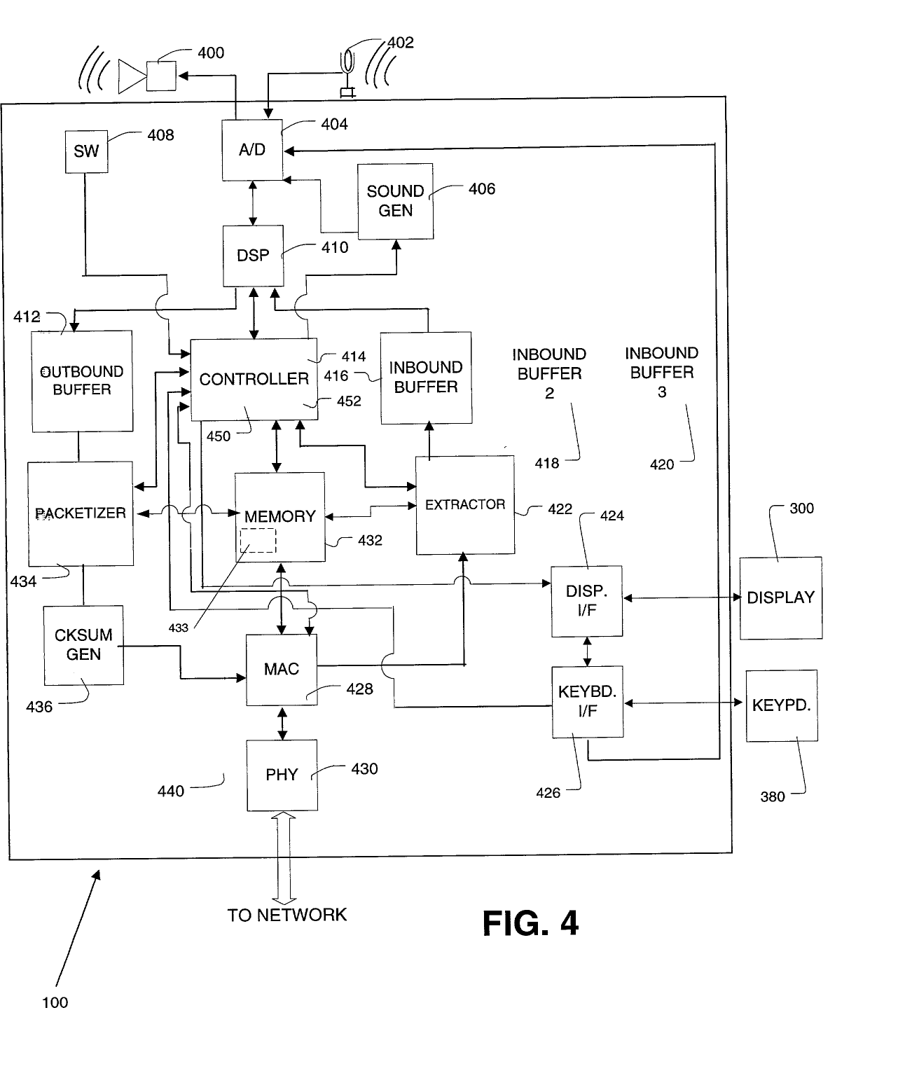

FIG. 4 is a schematic block diagram of the IP telephony peripheral according to the first and second embodiments of the invention. As shown therein, speaker 400 is communicatively coupled to analog/digital converter 404 for converting perceived speech into an appropriate digital form. Speaker 400 may be a component of the computer to which the peripheral is adjunct, or may be coupled to the peripheral itself via a known speaker connector. In this embodiment, analog to digital converter 404 converts acquired speech into PCM coded data representing voice sampled at sufficient sampling rate to ensure that at least conventional PSTN voice quality can be assured. Also coupled to analog/digital converter 404 is a sound generator 406 for providing alert tones in digital form to analog/digital converter 404 which it then converts it into appropriate analog format for transmission to the user via speaker 400 audio output device. Also coupled to analog/digital converter 404 is digital signal processor (“DSP”). DSP 410 is used for selectively encoding or decoding inbound and outbound digitized voice respectively using industry standard H.323 compression techniques. Also, DSP 410 is used to selectively encode or decode inbound or outbound digitized voice respectively using echo cancellation procedures well known in the art. Coupled to the output of DSP 410 is an outbound FIFO buffer 412 used for temporarily storing process digitized voice captured by the microphone 402 for subsequent delivery to the packetizer 434 described hereinbelow.

Packetizer 434 is coupled to the output of outbound buffer 412 to packetize the buffered and processed digitized voice into the payload of connectionless layer 3 Internet protocol (IP) upon authorization from controller 414. In the present embodiment, the packetizer latches in a number of octets defining digitized voice from the outbound buffer 412 for each layer 3 IP packet to be created. The packetizer then queries memory 432 for the desired destination IP address (or IP addresses in the case of a conference call), and builds an IP packet header information using at least one of the returned destination IP addresses, a predetermined source IP address specified for the IP telephony peripheral 100, and the number of octets latched in from buffer 412 (preferably a predetermined number to reduce circuit complexity and increase processing speed). The Vers, Hlen, Service Type (high priority streaming data), Total Length, Identification, Flags, Fragment Offset, Time to Live, Protocol (base IP), Header, Options, and any padding fields of the IP packet header can be obtained using the above-identified size and addressing information or through predefined or hard-coded values retained by the packetizer 434 or memory 432, as is well known in the art. Once each IP header is built (but for error correction checksum fields), the latched in digitized voice octets are placed into the data portion of the IP packet, and result is sent to the checksum generator 436.

Also, the packetizer 434 of the present embodiment is capable of generating predefined requests (i.e. the call request CALL_REQ or the forward request FWD_REQ or CAN_FWD) directed to the phone server 110 or a predefined NO_ANS error message to be relayed to the source IP address of an incoming call indicating that no answer has occurred. Each are generated in this embodiment by the packetizer 434 upon direction of the controller 414.

With respect to each of the aforementioned requests, the packetizer 434 will build the IP packet header of the IP packet embodying the request using the pre-established address of the IP telephony peripheral 100 as the source address and the pre-established IP address of the phone server 110 assigned to service the IP telephony peripheral 100. In the case of the call request (CALL_REQ) and forward request (FWD_REQ) requests, the data portion of the packet will include appropriate request identification information understood by both the telephone 100 and the phone server 110 as well as any user information captured from keypad 380 and relayed to the packetizer 434 by controller 414 for resolution by the aforementioned call model component 120 of the phone server 110. However, in the case of the cancel forward request, the data portion of the packet will only include request identification information used by the call model 120 of the phone server 110 to classify the request and cancel any existing forwarding state for the IP telephony peripheral 100 established via a prior forward request.

In the case of the NO_ANS request, the packetizer 434 of this embodiment builds an appropriate IP packet specifying the source IP address of a perceived and correctly routed incoming IP packet determined as being an incoming caller to notify this caller that VOIP communications cannot proceed at the present time. The data portion and format is not of true significance, and in fact any data can be placed in the data portion of the IP packet defining the IP request as long as the so-mentioned no answer notification can be ascertained by the calling device or terminal.

As mentioned previously, coupled to the output of packetizer 434 is check sum generator 436 for filling out error correction information (specifically, the Checksum field disposed within each IP packet header) for each of the request, error and streaming preferably PCM-digitized voice IP packets generated by packetizer 434. In turn, the output of checksum generator 436 is connected to the network interface 440 herein comprising media access controller (“MAC”) 428 coupled to a physical transport 430. In this embodiment, the network interface 440 is an IEEE 802.3 compliant Ethernet interface connecting to Ethernet network 130 using known Ethernet protocols and transport mechanisms. It should be realized here, however, that the teachings of the present invention are limited to any particular type of physical layer network interfacing or network transport as long as bidirectional transmission of layer 3 IP packets can be accomplished, as is well understood in the art. As such, other types of networks and accompanying interfaces such as token ring, ATM, SONET, modem- PPP or SLIP server are contemplated here without detracting from the teachings of the invention.

The physical transport 430 may contain a dedicated port or termination node to the network 130 or it may involve a pass-through connection serving as an intermediary between another network device such as a computer and the network 130. If so, the media access controller will employ collision avoidance mechanisms well known in the networking arts to avoid packet collisions with any other downstream attached device(s) to the physical layer 430.

Also, the media access controller 428 preferably intercepts and extracts at least the source and destination IP address information for inbound packets received from network 130 via the physical transport 430. The MAC 428 will retain IP packets having the same destination address as the IP telephone's predetermined IP address stored in memory 432, and will route onto the extractor 422 at least those retained packets indicating as a source address at least one of the destination IP addresses or indicating the predetermined destination address for the phone server 110. As discussed hereinbelow in greater detail with respect to incoming call processing shown in FIG. 5, retained IP packets specifying source address which does not match any of the established destination IP addresses or the phone server 110's pre-established address will be assumed in this embodiment to be an incoming call.

Still referring to FIG. 4, the extractor 422 is coupled to an output of the MAC 128 for receiving inbound packets matching the predetermined phone server 110 or established destination IP addresses stored in memory 432. The extractor will extract the digitized voice contained in these packets and pass it along to the inbound FIFO buffer 416. If conference features according to the present embodiment are supported, in addition, the extractor will be able to match the IP source address of the inbound packets to each of the established IP destination addresses stored in memory 432 and route the digitized voice samples therein to one of up to three different buffers 416, 418, and 420 corresponding to the established IP addresses. Although additional buffers above three can be supported (and so additional conferees can be supported), in this embodiment only up to three conferees are supported in view of practical needs for such conferencing as well as resulting additional circuitry complexity and components costs additional buffers would impart.

In addition, the extractor 422 of this embodiment will perceive one of the aforementioned replies (i.e. the connection reply CONN_REPLY or forward reply FWD_REPLY) or error messages (i.e. connection error CONN_ERROR or forward error FWD_ERROR) issued by the phone server 110 in response to requests issued by the IP telephony peripheral 100 by sequentially evaluating the source IP address and the data portion of the incoming IP packet if the source IP address matches the pre-established phone server IP address. If such replies or error messages are received, the data portions of each are submitted to the controller 414 of the present embodiment for processing in accordance with the state transition diagram shown in FIG. 5 and discussed in detail hereinbelow.

Still referring to FIG. 4, the output of each inbound FIFO buffer 416, 418, and 420 is coupled to DSP 410. In turn, as stated above, DSP 410 will take received digitized audio streams placed in these buffers as they are received and will selectively decode them using known echo cancellation and H.323 compression techniques. The decoded streams are then relayed on to analog/digital converter 404 for subsequent transmission in analog form to the user using speaker 400 or similar output device (not shown).

The controller 414 is coupled to the aforementioned packetizer 434, memory 432, the extractor 422, the media access controller 428 and the DSP 410 for sequencing call setup and packet transmission reception procedures according to the present embodiment. The controller herein will include phone server 450 and answer 452 timing resources for controlling internal timing for said processing as will be described hereinbelow with reference to the state transition diagram of FIG. 5. The controller 414 is adapted to perform wideband audio compression according to International Telecommunications Union (ITU-T) compliant schemes such as G.711, G723.1 and G.729A. Other wideband audio compression schemes, as known in the art, may also be employed.

The controller 414 is also communicatively coupled to display 360 to display interface 424 as well as keypad 380 through keypad interface 426. Display interface 424 will perform routine display operations of information provided by controller 414 as well as track keypad entry from keypad 380 responsive to the de-bounced keystrokes detected by keyboard interface 426. Likewise keypad interface 426 notifies controller 414 and display interface 424 what keys have been depressed by the user. In addition, keypad interface 426 could include a conventional DTMF sound generator (not shown) for placing DTMF sounds into the inbound and outbound voice streams.

Also coupled to controller 414 is off-hook switch 408 used for indicating the current hook state of the handset 370 of the IP telephony peripheral 100.

FIG. 5 is a state transition diagram executed by the controller 414 shown in FIG. 4 in isolation, or in conjunction with the other highlighted components of the IP telephony peripheral 100 according to the first embodiment of the present invention. The idle state is represented at 500. When a digit sequence terminating in a send (SND) key, or a sequence comprising a memory key plus one of digits 0-9 is detected by the controller 414, the controller transitions to state 502. At state 502, the controller 414 instructs the packetizer 434 to issue a call request to the phone server 110 (FIG. 1). In turn, the packetizer will query memory 432 for the phone server 110's IP address and then place a CALL_REQ IP packet to the phone server, as discussed above. The packetizer 434 will include information captured from the user using keypad 380 indicated before depression of the send (SND) key. Alternatively, the packetizer can consult a predefined memory table containing IP address entries corresponding to key sequence M0, M1, M2, . . . , N9 as is well known in the art. Also, in state 502, the controller resets a watchdog server time-out timer 450 used to indicate a period of time in which the IP telephony peripheral 100 is likely to receive a response from a connected phone server 110.

Thereafter control transitions to state 504 in which the controller 414 waits for a connection reply (CONN_REPLY) from the phone server 110 servicing the IP telephony peripheral 100. If the aforementioned server time-out timer 450 expires before receipt of the CONN_REPLY from the phone server 110, a SERV_TIMEOUT signal is issued and control transitions to error state 506. At state 506, a connection error is perceived by the controller 414. Likewise, if during the duration of the server timer 450 initialized in state 502, a connection error CONN_ERROR has been perceived by the controller 414 based on communications with the extractor 422, control likewise transitions to state 506. In either case, at state 506 a connection error tone is transmitted to the user and the status of the call counter variable is interrogated. When no calls have previously been established, in this embodiment, the control will transition back to the idle state 500. However, where the call counter is greater than 0 indicating that a successful connection has already been established as will be discussed hereinbelow, control transitions to the IP voice packet transmit and receive state 510.

If, however, while in state 504 a connection reply (CONN_REPLY) has been received before the server timer 450 has timed out, control instead transitions to state 508 in which the call counter is incremented, indicating that a successful telephony connection has been established with the destination. In addition, at this state the controller will add the resolved destination IP address specified in the connection reply to the memory 432. Also in this embodiment, a DTMF_EN enable flag is set indicating that the keypad interface 426 will generate DTMF tones responsive to the phone keys 350 (FIG. 3) selected by the user, as is well understood in the art. Thereafter, control transitions to state 510 where perceived voice is captured, digitized, packetized, and transmitted by the IP telephony peripheral 100 and inbound IP packets are received and assembled into inbound voice streams for replay over speaker 400 or similar output device.

Call termination processing according to the first embodiment is now detailed. From the transmit/receive state 510, if the controller perceives that the user has ended the call via the IP telephony peripheral screen GUI 300 by clicking the end call key 372 (END), and the off-hook switch is toggled to the on-hook state, control transitions to state 512. At state 512, it is assumed that the user wants to hang-up, so all the destination IP addresses are flushed from memory 432, the call counter is initialized to 0 and the DTMF_EN flag is cleared. Control thereafter transitions back to the idle state 500.

Call conferencing according to the first embodiment is now detailed. From the transmit/receive state 510 in which a call has already been established, if a conference key 330 is depressed by the user, the controller transitions back to state 502 in which the controller 414 instructs the packetizer to issue an appropriate call request. Control then transitions to state 504, 508, or 506 as outlined hereinabove. It should be noted here that since connectionless data transfer is contemplated using IP packets, the extra connection only involves verification or resolution by the call model 120 of the phone server 110 and receipt of the CONN_REPLY including the resolved destination IP address before the server timer 450 expires. Also, as stated previously, assuming that a successful conference connection has been made, extractor 422 will route the conferee's received digitized voice to inbound buffer 418 instead of inbound buffer 416 so as not to garble the incoming streaming audio data of the two called parties whose destination IP addresses are contained in memory 432. Also, as stated before, up to three callers (one original caller and up to two conferees) may be supported simultaneously.

An incoming call is handled by the IP telephony peripheral 100 of the first embodiment is now described with reference to FIG. 5. From the idle state 500, if the media access controller 128 determines that a received inbound IP packet specifies a source address not in the destination IP address list within memory 432, control transitions from the idle state to state 514. At state 514, the controller 414 instructs the sound generator 406 to send an alert tone to a ringer (not shown) to audibly indicate that an incoming call has been perceived, as with the case in a conventional analog phone. At the same time, the controller will initialize a watchdog answer timer 452 to time the duration of the ring before the handset is picked up. If the answer timer 452 times out before an off-hook state has been detected, control transitions to state 516 in which the controller instructs the packetizer to issue a predetermined NO_ANS error message IP packet to the calling party. Control thereafter transitions back to the idle state 500.

If, however, in state 514 controller perceives the off-hook state before the expiration of the answer timer 452's preset or adjustable duration, control instead transitions to state 508 which, as indicated above, the call counter incremented, the DTMF enabled flag is enabled and the calling party's originating IP address is added to the destination IP address list contained in memory 432. Control thereafter transitions to step 510 in which IP packet transmission and reception operations ensue. Call forwarding handled by the IP telephony peripheral 100 according to the first embodiment is now described with reference to FIG. 5. From the idle state 500, if the controller perceives that the forward key 340 has been selected by the user, control transitions to state 518. At state 518, the controller selectively issues a forward request (FWD_REQ) or a cancel forward request (CAN_FWD) to the phone server 110 utilizing the aforementioned packetizer 434, check sum generator 436, and network interface 440 based on the status of the forward enable FWD_EN flag contained in memory 432. It should be noted here that if the forward request is deemed appropriate, destination information will be incorporated into the forward request FWD_REQ IP packet as specified by the appropriate user entry using keypad 380 as discussed hereinabove with respect to initiating a call. Also, at state 518, the controller restarts the server timer 452.

Control thereafter transitions to state 520, in which the control awaits for a forward reply FWD_REPLY issued by the phone server 110. If the aforementioned server time-out timer 450 expires before receipt of the FWD_REPLY from the phone server 110, a SERV_TIMEOUT signal is issued and control transitions to error state 524. At state 524, a forward error is perceived by the controller 414. Likewise, if during the duration of the server timer 450 initialized in state 518, a forward error FWD_ERROR has been perceived by the controller 414 based on communications with the extractor 422, control likewise transitions to state 524.

At the error state 524, an alert tone is generated to the user in state 524 and control then transitions back to the idle state 500. However, if a forward reply FWD_REPLY is received from the phone server before the server timer times-out, control transitions to state 502 in which the forward enable flag is toggled enabled, meaning that the forward request has been perceived and stored by the phone server 110, or disabled, meaning that a previous filled request has been canceled by the forward by the phone server 110. Control thereafter transitions to the idle state 500.

It should be noted here that while the forward enable flag is set, controller will not initiate a call nor will it answer an incoming call.

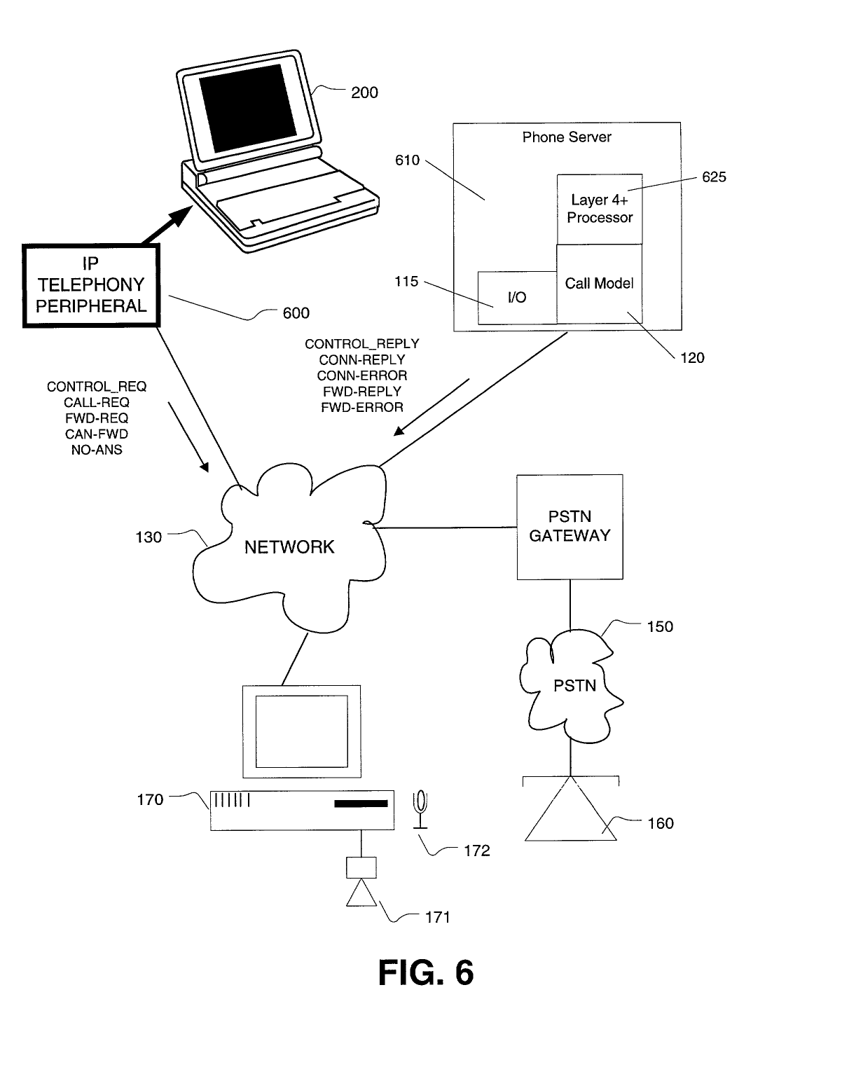

According to a second embodiment of the invention, an IP telephony peripheral—phone server tandem operates to set up and maintain voice over IP sessions with other IP telephony devices while preserving higher OSI layer (layer 4+) signaling (e.g. TCP/IP and/or ITU H.323) communications with these other telephony devices. According to this embodiment with reference to FIG. 6, the IP telephony peripheral 600 and the phone 610 server communicate using base IP (layer 3) protocols as is the case with the IP telephony peripheral 100 and server 110 described above with respect to the first embodiment of the invention. However, the IP telephony peripheral 600 will encapsulate the higher layer (layer 4+) control and signaling packets received from other telephony devices it has established a call or session with into layer 3 IP packets for transmission to the phone server 610.

According to the second embodiment, the phone server 610 includes a network aware I/O module 115 and call model 120 discussed previously, along with a layer 4+ processor 625 responsible for parsing the higher layer control and signaling packets forwarded by the IP telephony peripheral 600, and encapsulating the appropriate responses and control information in base layer 3 IP protocol for transmission back to the IP telephony peripheral 600. It should be noted that, except that the phone server knows to substitute origination information corresponding to the IP appropriate telephone 600 it is servicing rather than itself as the originator of these responses, conventional layer 4+ servicing routines may be conveniently utilized.

To make it appear to other telephony devices as though the IP telephony peripheral 600 that it is actually processing the layer 4+ control and signaling packets and thus appear as higher layer compliant, the IP telephony peripheral 600 (not the server 610) receives and transmits all higher layer packets to these telephony devices, including reissuing the higher layer control and signaling packets in native form sent to it by the server 610 encapsulated in base IP packets.

Thus, even though the server 610 according to this aspect of the present invention is given responsibility for actually acting on the layer 4+ commands, control and signaling packets used to e.g. set up an H.323 session, its operations and communications with the IP telephony peripheral 600 are transparent to the other telephony devices engaged in the communications session.

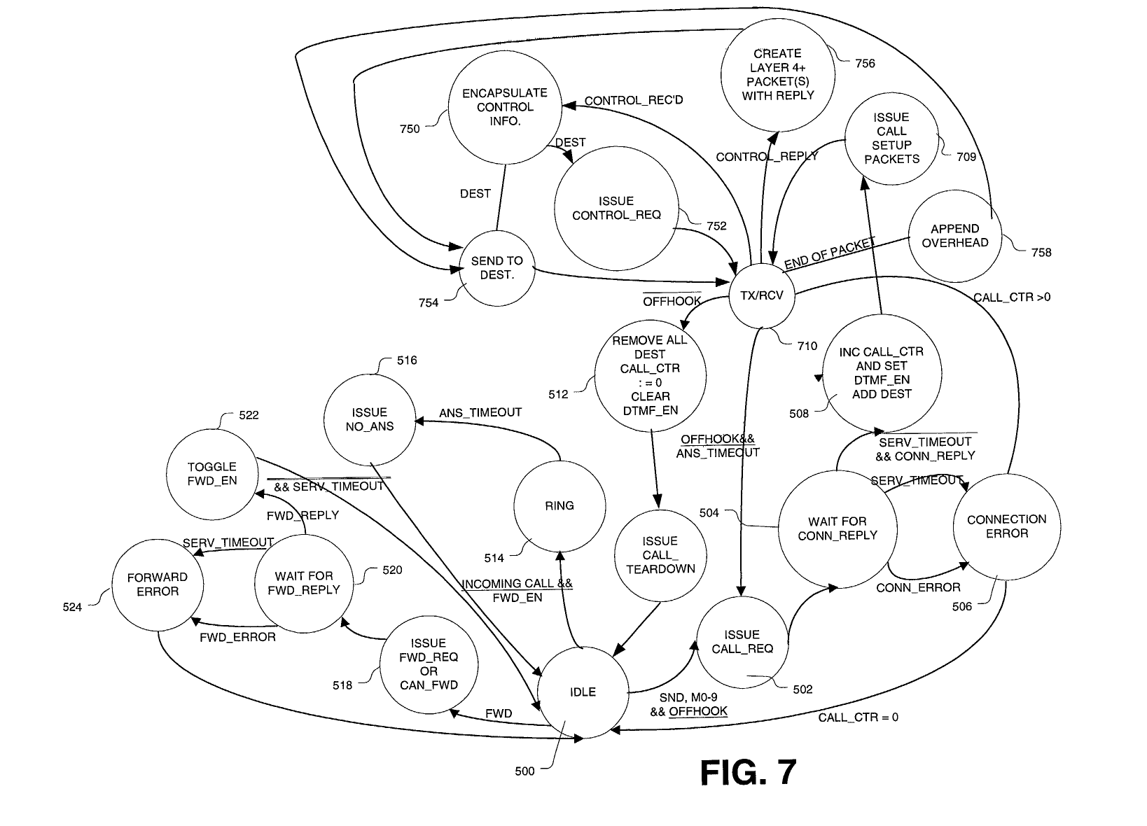

The functions of the telephone peripheral 600 as well as interactions with the phone server 610 may be best understood by referring to the telephone peripheral 600 controller state transition diagram of FIG. 7. As shown in FIG. 7, controller 414 processing is similar to that illustrated and described above with reference to FIG. 5, except as noted below. The primary difference is that, in this embodiment, once basic call setup is complete and call setup packets are broadcast from the IP telephony peripheral 600 (state 709), the controller 414 transitions to the TX/RCV state 710 to direct that layer 4+ voice and control packets (rather than layer 3) are created, issued, received, and voice information is extracted therefrom. Thus, when the payload of packet to be sent to other telephony devices using layer 4+ protocols such as TCP/IP or H.323 is full, the controller 414 transitions to state 758, in which the controller 414 directs that the packetizer 434 develop appropriate layer 4+ overhead (such as the TCP/IP packet sequencing number) in a routine manner. Thereafter, the controller transitions to state 754 where it directs the packetizer 434 and checksum generator 436 to create and deliver a complete layer 4+ packet to the MAC 428 for transmission across the network 130 to the other telephony device(s) engaged in a layer 4+ call or session with the telephone 600.

Next, assume that the controller 414 according to the second embodiment detects an incoming packet received by the extractor 422 in fact contains control information germane to the layer 4+ protocol being utilized for communications (CONTROL_REC'D) while at state 710. If so, the controller transitions to state 750, where it directs the packetizer 434 to encapsulate the entire received control packet (or alternatively just the control portion) into a layer 3 packet for transmission to the phone server 610. It should be noted here that the controller 414 and/or extractor 422 will determine if the received packet constitutes or includes layer 4+ control information by e.g. comparing the received header/payload portions against a predefined protocol table (not shown) in memory 433.

From state 750, the controller 414 thereafter transitions to state 754, in which the controller directs the packetizer 434, checksum generator 436 and MAC 428 to transmit the layer 3 packet encapsulating the layer 4+ control packet to the phone server 710.

Next assume that the controller 414 according to the second embodiment detects that an incoming packet or packet stream received by the extractor 422 in fact contains encapsulated control response information generated by the phone server 610 (CONTROL_REPLY) while at state 710. In such case, the controller 414 transitions to state 756, in which the controller directs the packetizer to create a layer 4+ packet including the control response information presented in the payload of the incoming layer 3 packet. The controller thereafter transitions to state 754, in which the controller directs the packetizer 434, checksum generator 436 and MAC 428 to transmit the layer 4+ packet(s) including the control response information to the other telephony device(s) engaged in the call or session with the IP telephony peripheral 600.

It should be noted here that non-control layer 4+ components (such as TCP/IP sequencing placed in the header of each TCP/IP packet bearing a voice payload) are discarded without reply where possible to simplify construction of the telephone 600.

While the invention is described above in terms of specific preferred embodiments and associated drawings, those of ordinary skill in the art will recognize that the invention can be practiced in other embodiments as well. It is felt therefore that the invention should not be limited to the disclosed embodiments above, but rather should be limited only by the spirit and scope of the appended claims.

What is claimed is:

1. An IP telephony peripheral for use adjunct to a computer and for use with a network, comprising:
a controller;
a computer interface communicatively coupled to said controller;
a memory coupled to said controller for selectively storing a destination IP address;
a packetizer coupled to said controller and said memory for packetizing outbound digitized voice into at least one outbound IP packet, said outbound IP packet including destination data based on said stored destination IP address; and
a network interface in communication with said memory for broadcasting said outbound IP packet onto said network.

2. The telephone of claim 1, wherein said controller comprises a finite state machine.

3. The telephone of claim 2, wherein said controller comprises a programmed microcontroller.

4. The telephone of claim 2, wherein said controller comprises a synchronous network of discrete logic components.

5. The telephone of claim 2, wherein said finite state machine, said memory, said packetizer, and said network interface are commonly housed in an ASIC.

6. The telephone of claim 2, wherein said network interface captures an inbound IP packet, said inbound IP packet including source data correlating to said destination IP address.

7. The telephone of claim 6, further comprising an extractor coupled to said network interface and said controller for extracting inbound digitized voice from said inbound IP packet.

8. The telephone of claim 7, wherein said destination IP address includes plural IP addresses.

9. The telephone of claim 2, further comprising:
a handset interface, said handset interface including a speaker connector for connecting a speaker and a microphone connector for connecting a microphone; and
an analog/digital converter coupled to said handset interface for converting acquired voice into said outbound digitized voice and for converting inbound digitized voice into analog form.

10. The telephone of claim 9, further comprising a digital signal processor coupled to said analog/digital converter, said controller, said packetizer, and said extractor for selectively performing echo cancellation and compression operations on said inbound and outbound digitized voice.

11. The telephone of claim 9, further comprising:
a graphical user interface, said graphical user interface having a keypad disposed on said graphical user interface; and
a keypad interface coupled to said controller, said keypad for detecting selection of at least one key and for selectively issuing a corresponding DTMF tone to said analog/digital converter.

12. The telephone of claim 2, wherein said network interface comprises:
a transparent transport coupled to said network, said transport including connection means for coupling a computer to said network and transporting computer data to and from said computer;
a media access controller coupled to said transport, said media access controller including collision enforcement means coupled to said transparent transport for broadcasting said outbound IP packet onto said network without influencing said computer data.

13. The telephone of claim 1, wherein said communicative coupling of a computer and said computer interface is through a radio communications link.

14. The telephone of claim 13, wherein said radio communications link conforms to Bluetooth specification.

15. The telephone of claim 1, wherein said communicative coupling of a computer and said computer interface is via a physical connector conforming to a Personal Computer Memory Card International Association standard.

16. The telephone of claim 1, wherein said communicative coupling of a computer and said computer interface is via a physical connector conforming to a Peripheral Component Interconnect standard.

17. The telephone of claim 1, wherein said communicative coupling of a computer and said computer interface is via a physical connector conforming to a Universal Serial Bus standard.

18. An IP telephony system, comprising:
an IP telephony peripheral, comprising:
a controller;
a computer interface coupled to said controller;
a memory coupled to said controller;
a packetizer coupled to said controller and said memory for packetizing a call request into an outbound IP packet; and
an interface for transmitting the outbound IP packet; and
a phone server in communication with said IP telephone, comprising:
an IP parser for parsing the call request from the transmitted outbound packet;
a call model for resolving a destination IP address from the extracted call request and transmitting the destination IP address to said IP telephone as an inbound IP packet;
wherein said IP telephony peripheral further comprises an extractor coupled to said controller, said memory, and said interface for extracting the destination IP address from the inbound IP packet and storing the destination IP address into said memory.

19. The IP telephony system of claim 18, wherein said packetizer packetizes outbound digitized voice into a stream of outbound IP packets, each outbound IP packet of the stream including destination data based on the stored destination IP address.

20. The telephony system of claim 19, wherein said telephone controller comprises a finite state machine.

21. An IP call establishment method, comprising the steps of:
receiving a call request from a graphical user interface on a computer;
packetizing the call request into an outbound IP packet;
transmitting the outbound IP packet;
remotely parsing the call request from the transmitted outbound packet;
remotely resolving a destination IP address from the extracted call request;
transmitting the destination IP address as an inbound IP packet;
extracting the destination IP address from the inbound IP packet; and
packetizing outbound digitized voice into a stream of outbound IP packets, each outbound IP packet of the stream including destination data based on the stored destination IP address.

22. The IP call establishment method of claim 20, further comprising the step of:
generating the call request responsive to user input on said graphical user interface.

23. A packet voice communications system, comprising:
a packet voice telephone peripheral for use adjunct to a computer, operable to receive a packet containing layer 4+ control information, encapsulate the layer 4+ control information into a lower level packet, and issue the lower level packet; and
a phone server coupled to said packet voice telephone and comprising:
an i/o module to receive the lower level packet; and
a layer 4+ processor to generate at least one response packet responsive to the layer 4+ control information encapsulated within the received lower level packet, wherein said i/o module issues the at least one response packet;
wherein the packet voice telephone receives the at least one response packet and issues an outbound response containing a portion of the at least one response packet.

24. A packet voice communications system, comprising:
a packet voice telephone peripheral comprising:
means for receiving a call request from a graphical user interface on a computer;
means for receiving a packet containing layer 4+ control information;
means for encapsulating the layer 4+ control information into a lower level packet; and
means for issuing the lower level packet; and a phone server, comprising:
means for receiving the lower level packet; and
means for generating at least one response packet responsive to the layer 4+ control information encapsulated within the received lower level packet, wherein said phone server receiving means includes issuing means for issuing the at least one response packet;
wherein the packet voice telephone peripheral receiving means receives the at least one response packet and includes issuing means for issuing an outbound response containing a portion of the at least one response packet.

25. An article including one or more machine-readable storage media containing instructions to control an IP telephony peripheral apparatus in a communications network, the instructions when executed causing a controller to:
transmit a call request to the IP telephony peripheral apparatus responsive to an activation command on a computer;
wherein the call request comprises control information to selectively control the operation of the IP telephony peripheral.
